(19) United States
(12) Patent Application Publication
(10) Pub. No.: US 2017/0171721 A1
(43) Pub. Date: Jun. 15, 2017

(54) BLUETOOTH PROTOCOL BROADCASTING SYSTEM

(71) Applicant: LINEAR DMS SOLUTIONS SDN. BHD., BUKIT GELUGOR (MY)

(72) Inventors: Jiung Ming WANG, Bukit Gelugor (MY); Ming Kai CHAI, Bukit Gelugor (MY)

(73) Assignee: LINEAR DMS SOLUTIONS SDN. BHD., BUKIT GELUGOR (MY)

(21) Appl. No.: 15/075,035

(22) Filed: Mar. 18, 2016

(30) Foreign Application Priority Data
Dec. 10, 2015 (MY) PI 2015704509

(51) Int. Cl. H04W 4/06; H04W 4/02; H04W 24/08; H04W 4/00; H04B 17/318

(52) U.S. Cl. CPC H04W 4/06; H04W 4/008; H04B 17/318; H04W 24/08; H04W 4/023

(57) ABSTRACT

In one embodiment, a broadcasting apparatus include a module circuit, a first antenna circuit and a second antenna circuit. The module circuit generates first and second signals having a content that includes particular information. In addition to that, the first and second signals are in accordance to a Bluetooth transmission protocol. The first antenna circuit may receive the first signal and broadcast the first signal out from the broadcasting apparatus. The second antenna circuit may receive the second signal and broadcast the second signal after the first signal is broadcasted.

### TECHNICAL FIELD

Embodiments described herein include a Bluetooth protocol broadcasting system.

### BACKGROUND

Bluetooth low energy (BLE) is a specification that enables radio frequency (RF) communications between various devices. In recent times, the BLE applications have impacted how information is communicated to us while we walk, shop, etc. For example, the BLE applications can be seen in proximity marketing solutions and also in positioning applications. Going to a shopping mall and activating the Bluetooth capability on a portable device enables the portable device to receive all sorts of informative contents, for example, advertisements, marketing material, etc. from multiple shops in the shopping mall.

Furthermore, a portable device may selectively receive the contents only when the device owner is within a proximity of a Bluetooth transmission apparatus (i.e., used as a positioning application). Hence, standing inside/outside a shop, and activating the Bluetooth capability on the portable device, enables the device owner to get all the contents that the shop wishes to provide to the device owner. Similarly, standing inside/outside of another shop may enable the device owner to get all the contents that the other shop wishes to provide to the device owner.

One of the problems commonly faced by the device owners is when there are two or more Bluetooth transmission apparatuses within a proximity range of the portable device. Generally, the strength of RF signal may indicate which Bluetooth transmission apparatus is the nearest. However, when a portable device is very near to the Bluetooth transmission apparatus, the signal strength may get affected (i.e., a significant dip in the signal strength) making a different Bluetooth transmission apparatus, which is located further, to be indicated as the nearest Bluetooth transmission apparatus. Such phenomenon may also be referred to as a glitch or inaccuracy. Hence, the information content within the received signal once processed may provide inaccurate and misleading information to the portable device owner functioning as a location based pin-pointer on a digital graphical map.

### SUMMARY

Embodiments described herein include a Bluetooth protocol broadcasting system. It should be appreciated that the embodiments can be implemented in numerous ways, such as a process, an apparatus, a system, a device, or a method. Several embodiments are described below.

In one embodiment, a broadcasting apparatus include a module circuit, a first antenna circuit and a second antenna circuit. The module circuit generates first and second signals having a content that includes particular information uniquely synchronized between first and second signals. In addition to that, the first and second signals are generated in accordance to a Bluetooth transmission protocol. The first antenna circuit may receive the first signal and broadcast the first signal out from the broadcasting apparatus. The second antenna circuit may receive the second signal and broadcast the second signal after the first signal is broadcasted.

In another embodiment, a method of operating a broadcasting apparatus may include a step to generate first and second signals that are in accordance to a Bluetooth transmission protocol. The first and second signals may have their contents that include first information. The methods also include a step to broadcast the first signal out from the broadcasting apparatus. And finally, the method also includes a step to broadcast the second signal out from the broadcasting apparatus after the first signal is broadcasted.

In alternative embodiment, a method of receiving broadcasted information may include a step to receive a first signal that is in accordance to a Bluetooth transmission protocol and is having contents that include first information. The method also include a step to predetermine that a receivable second signal is in accordance to a Bluetooth transmission protocol and is having contents that include the first information. The method may include a step to receive the second signal. Subsequently, the method include a step to determine whether the first and second signals are having contents that include the first information, whether an averaged received signal strength indicator (RSSI) value of the first and second signals is above a predefined value and/or whether a differences between RSSI values of the first and second signals is within a predefined value. The step to process the first information is performed only when the first and second signals are having identical contents (i.e., the first information), when the averaged RSSI value between the first and second signals is above the predefined value and the differences between RSSI values of the first and second signals is within the predefined value.

Further features of the invention, its nature and various advantages will be more apparent from the accompanying drawings and the following detailed description of the preferred embodiments.

### BRIEF DESCRIPTION OF DRAWINGS

FIG. 1 shows an illustrative broadcasting apparatus in accordance with one embodiment of the present invention.

FIG. 2 shows an illustrative exemplary sequence of signals that are broadcasted from a broadcasting apparatus in accordance with one embodiment of the present invention.

FIG. 3 shows an illustrative broadcasting system with one or more Portable device that is interacting with each other in accordance with one embodiment of the present invention.

FIG. 4 shows an illustrative broadcasting system that includes two broadcasting apparatus in accordance with one embodiment of the present invention.

FIG. 5 shows an illustrative multiple broadcasting apparatuses and portable devices in accordance with one embodiment of the present invention.

FIG. 6 shows a flowchart of an illustrative method for operating a broadcasting apparatus in accordance with one embodiment of the present invention.

FIG. 7 shows a flowchart of an illustrative method for operating a portable device in accordance with one embodiment of present invention.

### DETAILED DESCRIPTION

The following embodiments include a Bluetooth protocol broadcasting system. It will be obvious, to one skilled in the art, that the present exemplary embodiments may be practiced without some or all of these specific details. In other instances, well-known operations have not been described in detail in order not to unnecessarily obscure the present embodiments.

Throughout this specification, when an element is referred to as being “connected” or “coupled” to another element, it may be directly connected or coupled to the other element or electrically connected or coupled to the other element with yet another element interposed between them.

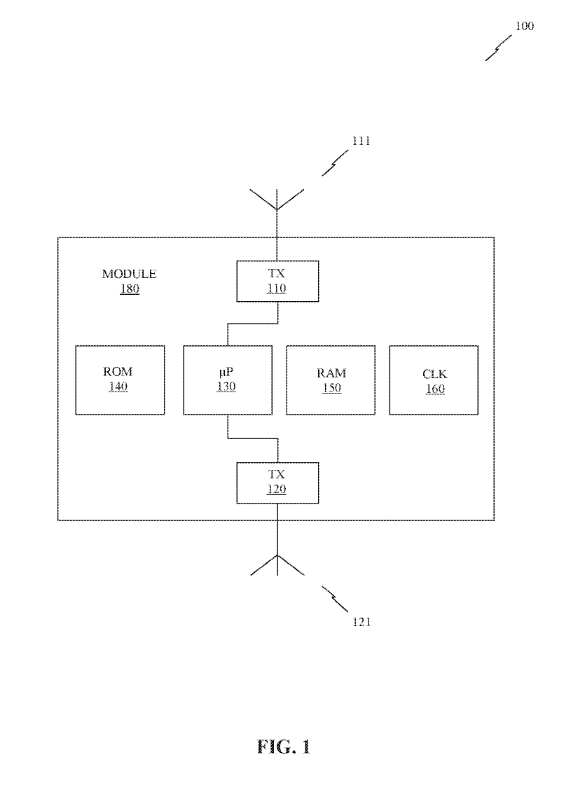

FIG. 1, meant to be illustrative and not limiting, illustrates a broadcasting apparatus in accordance with one embodiment of the present invention. As shown in the embodiment of FIG. 1, broadcasting apparatus (100) includes module (180) and two antennas (111) and (121). Module (180) may include read only memory (ROM) circuit block (140), processing circuit (P) block (130), random access memory (RAM) circuit block (150), clock circuitry (CLK) (160) and transmitter (TX) circuit blocks (110) and (120), as shown in the embodiment of FIG. 1. It should be appreciated that there may be other circuits within module (180). For example, module (180) may also include a universal asynchronous receiver/transmitter (UART) circuit block, a serial peripheral interface (SPI) circuit block, a joint test action group (JTAG) circuit block, a temperature sensor, humidity sensor, ambient light sensor, motion sensor and etc. In one embodiment, module (180) may be a Bluetooth smart chip (e.g., CSR 1010 device).

Broadcasting apparatus (100) may be utilized to broadcast information to portable devices (e.g., mobile devices such as mobile phones, tablets, or another receiving devices, etc.) that are located within a broadcasting range of broadcasting apparatus (100). Hence, broadcasting apparatus (100) may also be referred as a transmitting beacon, in one embodiment. The information that is broadcasted may be advertisements or push messages of a particular retail shop, promotions/information of a shop, etc. In essence, broadcasting apparatus (100) may be able to broadcast any information to a person who is within proximity having a portable device with an activated Bluetooth module.

In one embodiment, broadcasting apparatus (100) may broadcast multiple signals carrying the information. For example, broadcasting apparatus (100) may broadcast a first signal that includes first information. Subsequently, broadcasting apparatus (100) may broadcast a second signal, which may also include the first information. The second signal may be broadcasted after a uniquely predefined (known to portable device or receiving devices) period (e.g., approximately 100 milliseconds) after the first signal, in one exemplary embodiment.

In addition to that, broadcasting apparatus (100) may broadcast third and fourth signals, which may include identical information (i.e., the first information) as included in the first and second signals. The third signal may be broadcasted at least a predefined period (e.g., 100 milliseconds) after the second signal is broadcasted. Similarly, the fourth signal may be broadcasted at least another predefined period (e.g., 100 milliseconds) after the third signal is broadcasted.

In an alternative embodiment, broadcasting apparatus (100) may broadcast third and fourth signals, which may include different information than the information included in the first and second signals. Each of these signals (i.e., the first, second, third and fourth signals) broadcasted from broadcasting apparatus (100) may be in accordance to the Bluetooth transmission protocol, in one embodiment.

It should be appreciated that broadcasting a signal may also be termed as transmitting a signal from a device (e.g., broadcasting apparatus (100)) through an air medium to another device (e.g., a portable device). Hence, the term broadcasting may be interchangeably used with transmitting, relaying, airing, beaming and providing signals.

The broadcasting range of broadcasting apparatus (100) depends on multiple factors. In one exemplary embodiment, the broadcasting range may depend on: (a) the signal power of a broadcasted signal, (b) the type of antenna utilized to broadcast the signal, (c) the location of the antenna on broadcasting apparatus (100), (d) the location of broadcasting apparatus (100) relative to a portable device, and (e) the receiving sensitivity of a receiver. In one embodiment, only portable devices located within 100 meters of broadcasting or limited to Bluetooth wireless range apparatus (100) may receive the broadcasted information.

Broadcasting apparatus (100) should be placed in fixed known identified location in order to effectively simulate the broadcasted the signals towards its targeted audience with a portable device. For example, broadcasting apparatus (100) is placed indoor and just above the shop (e.g., on a ceiling or on a wall) in order to effectively broadcast the signals to the targeted users of a store within a shopping mall. However, for a shop lot located outside of a shopping mall, broadcasting apparatus (100) may be placed outdoor (e.g., at the entrance to a building) in order to effectively broadcast the signals to the targeted users.

The targeted users of broadcasting apparatus (100) depends on the content of the information that broadcasting apparatus (100) is broadcasting. For example, targeted audience may include potential customers that are located within 100 meters near the store that housed broadcasting apparatus (100).

Referring still to FIG. 1, two antennas (111) and (121) are coupled to module (180). In one embodiment, antennas (111) and (121) may be coupled externally to module (180) (i.e., located outside of module (180), as shown in the embodiment of FIG. 1). Alternatively, antennas (111) and (121) may be formed within module (180) (not shown). The two antennas (111) and (121) are passive components within broadcasting apparatus (100) that helps to transmit the signals generated by module (180). Furthermore, antennas (111) and (121) may be coupled to module (180) on edges that are located opposite to each other, as shown in the embodiment of FIG. 1. A person skilled in the art appreciates that antennas (111) and (121) are placed on opposite edges of module (180) in order to provide a unique orientation or arrangement and to increase the effectiveness of broadcasting apparatus (100). In one embodiment, antennas (111) and (121) may be strip-line antennas. In an alternative embodiment, antennas (111) and (121) may be wire-line antennas. A designer of a broadcasting apparatus (e.g., broadcasting apparatus (100)) may utilize any types of antenna that is suitable in a desired application.

Within broadcasting apparatus (100), module (180) may be utilized to generate signals that include the information content Module (180) may be a Bluetooth module, for example Bluetooth low energy (BLE) module. In one embodiment, module (180) may also be referred to as a “Bluetooth Smart” module when engaging Bluetooth 4.x technology. The Bluetooth Smart module may generate a radio frequency signal that operates in a spectrum that ranges between 2.400 gigahertz (GHz)-2.483 GHz.

Module (180) generates the two signals that carry identical information content. The two signals may be generated sequentially in a synchronized manner. For example, the second signal may be generated a predefined period (e.g., 100 milliseconds) after the first signal was generated. In addition to that, module (180) may also generate an additional two signals. These two additional signals may include identical information as the two earlier signals or different information compared to the two earlier signals. These two new signals may also be generated in sequential order in a synchronized manner.

In one exemplary embodiment, the signals may include: (a) the Bluetooth transmission protocol information, (b) the type of advertisement to be transmitted through this signal, (c) the size of advertisement, and (d) content information data in this signal. The generated signals may be digital signals (i.e., a sequence of binary values that include ‘1’s and ‘0’s) prior to becoming in radio frequency signals.

The signals are transmitted to their respective transmitter circuits (e.g., transmitters (110) or (120)). In one exemplary embodiment, the first signal may be transmitted to transmitter (110) and the second signal may be transmitted to transmitter (120). Subsequently, the first signal is transmitted from transmitter (110) to antenna (111), where it is then broadcasted out through antenna (111). The second signal, on the other hand, may be transmitted from transmitter (120) to antenna (121), where it is then broadcasted out through antenna (121).

Referring still to FIG. 1, processing circuit (130) may be programmed to generate signals (the first, second, third and fourth signals) that are mentioned above. In one embodiment, processing circuit (130) may be a reduced instruction set computing (RISC) microcontroller circuit. The instruction set that can be utilized to control the RISC microcontroller circuit may be a 16-bit instruction set, a 32-bit instruction set or a 64-bit instruction set. Alternatively, processing circuit (130) can also be a complex instruction set computing (CISC) processing circuit. Although, for a Bluetooth low energy module, it is preferred to have the RISC microcontroller circuit, which generally consumes less power than a CISC processing circuit. Processing circuit (130) may be selected from a group of processing circuitry such as a general purpose processors (GPP), a digital signal processors (DSP), an application specific instruction set processor (ASIP) or an application specific integrated circuit (ASIC).

Processing circuit (130) may generate the signals based on the instructions that are read from ROM circuit block (140). ROM circuit block (140) may include information that is provided and stored by a user. The information may include: (a) the standards at which the signals are to be generated, (b) the types of advertisement, (c) the size of an advertisement, and (d) the number of times the advertisement may have been broadcasted. In one exemplary embodiment, ROM circuit block (140) may have a size of 512 kilobytes (KBs). Generally, ROM circuit block (140) may be a non-volatile memory circuit, for example, an electrically erasable programmable read-only memory (EEPROM) circuit block.

RAM circuit block (150) provides a temporary storage for processing circuit (130). It should be appreciated that RAM circuit block (150) may be sufficiently large to enable data processing by processing circuit (130). In one embodiment, RAM circuit block (150) may have a size of 64 KBs. RAM circuit block (150) may include static random-access memory elements or dynamic random-access memory elements. Examples of dynamic random-access memory may include a double data rate (DDR) dynamic random-access memory (DRAM), a double data rate 2 (DDR2) DRAM, a double data rate 3 (DDR3) DRAM and a reduced latency dynamic random access memory (RLDRAM).

Clock circuitry (160) generates a clock signal based on an input clock signal and transmits the generated clock signal to almost all of the circuits within module (180) (e.g., processing circuit (130), ROM circuit block (140), RAM circuit block (150) and transmitters (110) and (120)). It should be appreciated that, clock circuitry (150) may also be referred to as clock generator circuit. In one embodiment, processing circuit (130) may utilize the clock signal generated by clock circuitry (160) in order to generate the first, second, third and fourth signals in sequential manner. Clock circuitry (160) may be a delay-locked loop (DLL) circuit or a phase-locked loop (PLL) circuit, in one embodiment.

Referring still to FIG. 1, transmitters (110) and (120) are coupled to processing circuit (130). In one embodiment, the first signal generated by processing circuit (110) may be transmitted to transmitter (110). The second signal, which is generated after a predefined fixed period from the time the first signal is generated, is transmitted to transmitter (120). Similarly, the third signal that was generated by processing circuit (110) may be transmitted to transmitter (110). The fourth signal, which was generated after a predefined fixed period from the time the third signal is generated, is transmitted to transmitter (120). Transmitters (110) and (120) may convert the received digital signals into RF signals and transmit these RF signals to their respective antennas (111) and (121).

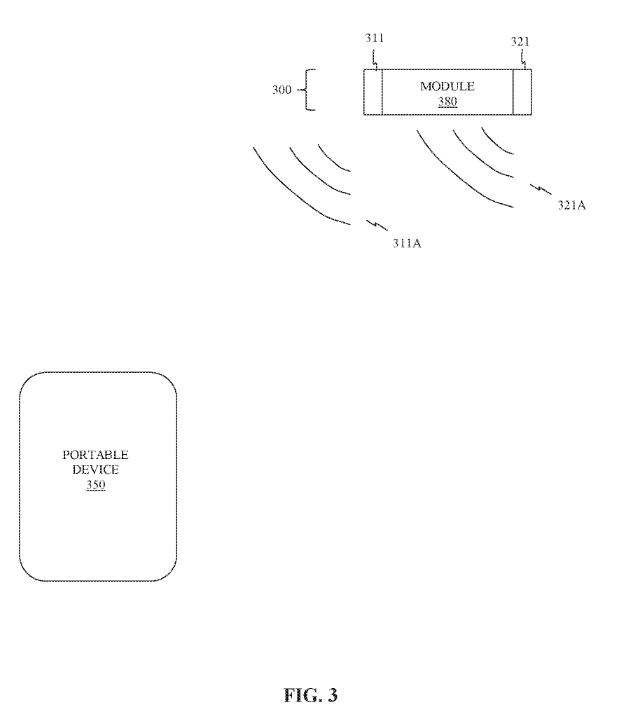

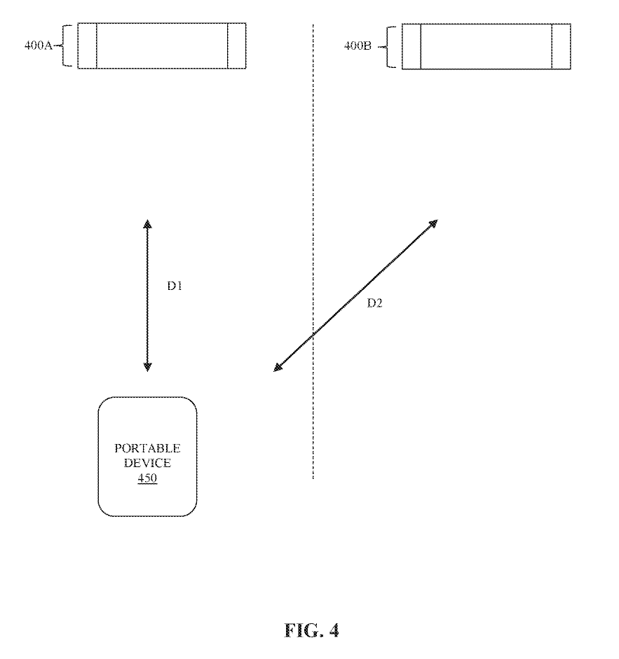

In one embodiment, the signals are broadcasted using two different antennas (111) and (121) in order to bypass glitch issue when a portable device receives signals from multiple broadcasting apparatus (e.g., multiple broadcasting apparatuses (100)). Hence, when a portable device is significantly near broadcasting apparatus (100), transmitting signals using two different antennas (111) and (121) may ensure that only information from the signals broadcasted by a nearest broadcasting apparatus is processed. Further details may be provided with reference to FIGS. 3 and 4.

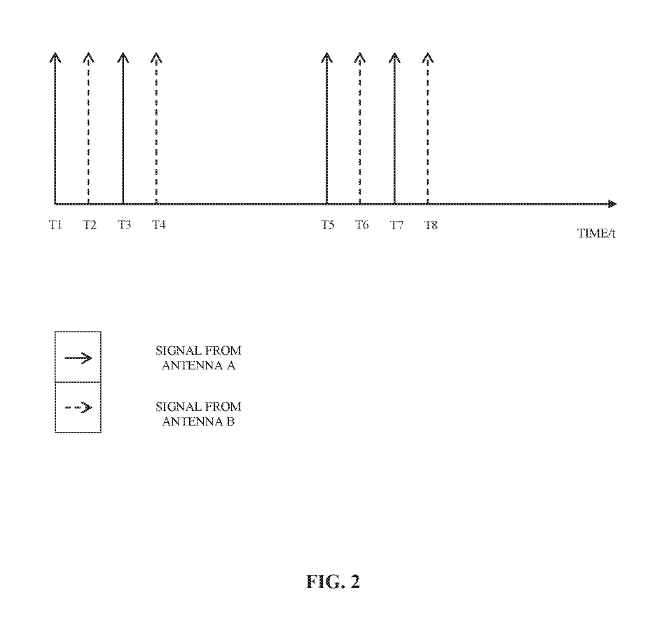

FIG. 2, meant to be illustrative and not limiting, illustrates an exemplary sequence of signals that are broadcasted from a broadcasting apparatus in accordance with one embodiment of the present invention. In one embodiment, the broadcasting apparatus may be similar to broadcasting apparatus (100) of FIG. 1.

In FIG. 2, a signal from antenna A is broadcasted at T1. Antenna A may be similar to antenna (111) of FIG. 1, in one embodiment. The signal that was broadcasted at T1 may have contents that include first information. Subsequently, at T2, another signal is broadcasted from antenna B. The time difference between T1 and T2 is a predefined period (e.g., 100 milliseconds). In the above embodiment, antenna B may be similar to antenna (121) of FIG. 1. The signal broadcasted at T2 may have contents that also include the first information. The first information, in one embodiment, may include advertisement/promotional contents of a store or a specific unique location.

In one embodiment, the signals broadcasted at T1 and T2 should have identical information (i.e., the first information) in order for a portable device to process the information within the signal. Having identical information signals at T1 and T2 may help to resolve the glitch issue that was mentioned in the background. For example, when the portable device receives the signals that may have different information at T1 and T2 as a result of a glitch, the portable device may reject the received signals. However, when the portable device receives the signals that may have identical information at T1 and T2; the portable device may process the signals. Therefore, the two signals broadcasting identical information (e.g., signals at T1 and T2) may decrease/eliminate the probability of misleading advertisement on the portable device when there are multiple broadcasting apparatuses within a range of the portable device.

At T3, another signal is broadcasted from the antenna A. The signal broadcasted at T3 may have contents that include identical information as the first information. In one embodiment, the signal may be similar to the third signal as mentioned under FIG. 1. At T4, another signal is broadcasted from antenna B. The signal broadcasted at T4 may also have contents that include identical information as the first signal. In one embodiment, the signals at T3 and T4 may be similar to the third and fourth signals, respectively, that were mentioned under FIG. 1.

Referring still to FIG. 2, after a fixed predefined period of rest to save power and delay, another signal from antenna A is broadcasted at T5. However, at this instance, the signal broadcasted at T5 may have contents that include second information (which is different than the first information). Subsequently, at T6, another signal is broadcasted from antenna B. The signal broadcasted at T6 may have contents that also include the second information. The second information may include information on a particular advertisement/promotional content of a store, which is different than the first information.

At T7, another signal is broadcasted from the antenna A. The signal at T5 may have contents that include identical information as the second information. At T8, another signal is broadcasted from antenna B. The signal broadcasted at T4 may also have contents that include identical information as the second information. In one embodiment, signals broadcasted at T5, T6, T7 and T8 may be similar to the first, second, third and fourth signals, respectively, as mentioned in FIG. 1.

FIG. 3, meant to be illustrative and not limiting, illustrates a broadcasting system in accordance with one embodiment of the present invention. The broadcasting system includes broadcasting apparatus a (300) and portable device or another receiving device (350). In one embodiment, broadcasting apparatus (300) may be similar to broadcasting apparatus (100) of FIG. 1. Hence, module (380) and antennas (311) and (321) of broadcasting apparatus (300) may be similar to module (180) and antennas (111) and (121), respectively, of FIG. 1. Therefore, for the sake of brevity, the details of module (380) and antennas (311) and (321) will not be repeated.

Referring still to FIG. 3, broadcasting apparatus (300) may broadcast signals 311A through antenna (311) and signals 321A through antenna (321). Signals (311A) and (321A) may be broadcasted sequentially. For example, signal (311A) may be broadcasted first and after a uniquely predefined period, signal (321A) may be broadcasted. In one embodiment, signal (311A) may be similar to the signal broadcasted at T1 of FIG. 2 and signal (321A) may be similar to the signal broadcasted at T2 of FIG. 2. Signals (311A) and (321A) may have identical contents and may be in accordance to a Bluetooth transmission protocol.

Portable device (350) receives both signals (311A) and (321A) from broadcasting apparatus (300). It should be appreciated that portable device (350) may be within a broadcasting range of broadcasting apparatus (300). In one exemplary embodiment, portable device (350) may be within 100 meters or of Bluetooth broadcasting range of broadcasting apparatus (300).

Portable device (350) may be any type of handheld devices or fixed point receiving device. For example, portable device (350) may be a mobile phone, a tablet, and etc. In one embodiment, portable device (350) may include a processing circuit. The processing circuit may help to process the information retrieved from received signals (311A) and (321A). In addition to that, portable device (350) may also include a Bluetooth module. The Bluetooth module may be utilized to receive signals (311A) and (321A) that are in accordance to Bluetooth transmission protocol.

In one exemplary embodiment, after portable device (350) receives signals (311A), portable device (350) predetermines that a next receivable signal in prior accordance made know may include identical information as signal (311A). When signal (321A) is received, portable device (350) determines whether the information is identical to the information content of signal (311A). If portable device (350) determines the information contents are identical, portable device (350) may process the information. However, if portable device (350) determines the information contents are different or out of predetermined levels of acceptance, portable device (350) may reject the information received by signals (311A) and (321A).

In another exemplary embodiment, after receiving signals (311A) and (321A), portable device (350) may determine received signal strength indicator (RSSI) values of signals (311A) and (321A). If differences between the RSSI values are less than a predefined value, portable device (350) may process the information within signals (311A) and (321A). However, if the differences between the RSSI values are more than the predefined value, portable device (350) may reject the information within signals (311A) and (321A). In one embodiment, the predefined value may be 10 decibel-milliwatt (dBm).

In another exemplary embodiment, after receiving signals (311A) and (321A), portable device (350) may determine an averaged signal strength indicator (RSSI) value of signals (311A) and (321A). If averaged RSSI is more than a predefined value, portable device (350) may process the information within signals (311A) and (321A). However, if the averaged RSSI value is less than the predefined value, portable device (350) may reject the information within signals (311A) and (321A).

The three exemplary embodiments above provide the manner in which broadcasting apparatus (300), by using signals (311A) and (321A), determines a nearest broadcasting apparatus for a portable device. The three manners (i.e., two signals (311A) and (321)) are checked for identical information content, having differences in RSSI values below the predefined value and having the averaged RSSI value above another predefined value) in which is described may resolve glitches that arises when portable device (350) is too near to broadcasting apparatus (300).

FIG. 4, meant to be illustrative and not limiting, illustrates another broadcasting system that includes two broadcasting apparatus in accordance with one embodiment of the present invention. The broadcasting system includes broadcasting apparatus (400A) and (400B) and portable device (450). In one embodiment, broadcasting apparatus (400A and 400B) may be similar to broadcasting apparatus (100) of FIG. 1. Similarly, portable device (450) may be similar to portable device (350) of FIG. 3. Therefore, the details will not be repeated for the sake of brevity.

As shown in the embodiment of FIG. 4, broadcasting apparatuses (400A) and (400B) may be located adjacent to each other. In one embodiment, broadcasting apparatuses (400A) and (400B) may be positioned in different shops that are located adjacent to each other. Each of these broadcasting apparatuses (400A) and (400B) may broadcast signals that include different advertisements as its contents.

Referring still to FIG. 4, portable device (450) may be located at a distance D1 from broadcasting apparatus (400A) and at a distance D2 from broadcasting apparatus (400B). The distance D1 may be smaller than distance D2.

In one exemplary embodiment, when the distance D1 is less or equal to a broadcasting range (e.g., 100 meters) and the distance D2 is greater than the broadcasting range, portable device (450) may only process signals broadcasted from broadcasting apparatus (400A) to determine accurately that apparatus (400A) is nearest to portable device (450).

In another exemplary embodiment, when the distances D1 and D2 are greater than the broadcasting range, portable device (450) may not process any signals broadcasted from broadcasting apparatuses (400A) and (400B).

In another exemplary embodiment, when the distances D1 and D2 are less than the broadcasting range, portable device (450) may only process signals broadcasted from a nearest broadcasting apparatus (in the embodiment of FIG. 4, that will be broadcasting apparatus (400A)). In addition to that, even with a glitch whereby there is a significant dip in signal strength of signals broadcasted from broadcasting apparatus (400A), portable device (450) may reject both of these signals broadcasted from broadcasting apparatuses (400A) and (400B), and await for new signals in order to not mislead or wrongly provide a decision.

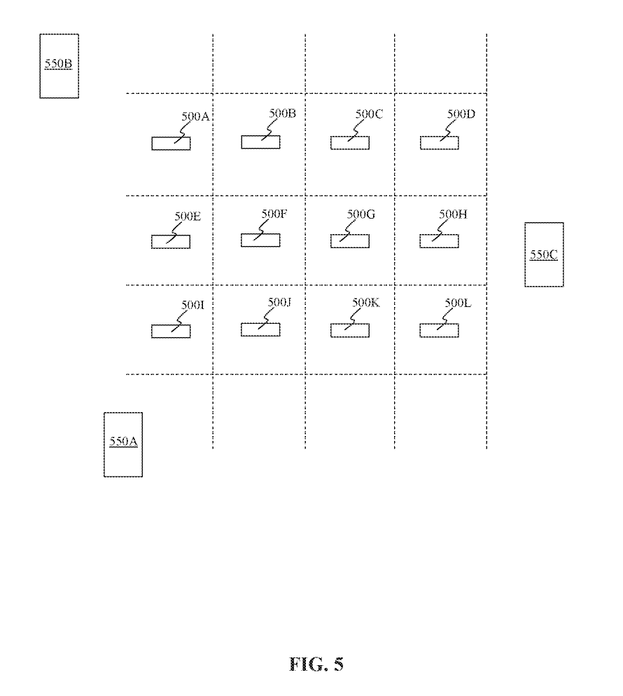

FIG. 5, meant to be illustrative and not limiting, illustrates multiple broadcasting apparatuses and portable devices in accordance with one embodiment of the present invention. As shown in the embodiment of FIG. 5, broadcasting apparatuses (500A-500L) may be similar to broadcasting apparatus (100) of FIG. 1, broadcasting apparatus (300) of FIG. 3 or broadcasting apparatuses (400A) and (400B) of FIG. 4. In addition to that, portable devices (550A-550C) may be similar to portable device (350) of FIG. 3 or portable device (450) of FIG. 4. Therefore, for the sake of brevity, the details of broadcasting apparatuses (500A-500L) and portable devices (550A-550C) will not be repeated.

As shown in the embodiment of FIG. 5, portable devices (550A-500C) may be within a proximity range of multiple broadcasting apparatus (500A-500L). However, portable device (550A) may only process signals transmitted from broadcasting apparatus (500I), portable device (550B) may only process signals transmitted from broadcasting apparatus (500A) and portable device (550C) may only process signals transmitted from broadcasting apparatus (500H). This is because, for portable device (550A), signal strength of the signals transmitted from broadcasting apparatus (500I) may be greatest amongst broadcasting apparatuses (500A-500L). Similarly, signal strengths from broadcasting apparatuses (500A) and (500H) may be greatest amongst broadcasting apparatuses (500A-500L) for portable devices (550B) and (550C), respectively.

Each of these broadcasting apparatuses (500A-500L) may transmit two signals that include identical contents from two different antennas (i.e., antennas (111) and (121) of FIG. 1). When there is a glitch, for example, a highest power first signal received by portable device (550A) is from broadcasting apparatus (500I) and a highest power second signal received by portable device (550A) is from broadcasting apparatus (500J), the portable device (550A) may reject the contents of the signals as they are not identical. In addition to that, portable device (550A) may also reject these signals as the average received signal strength indicator (RSSI) may be less than a predefined value and the differences between the RSSI values of these may be less than a predefined value (e.g., 10 decibel-miliwatts).

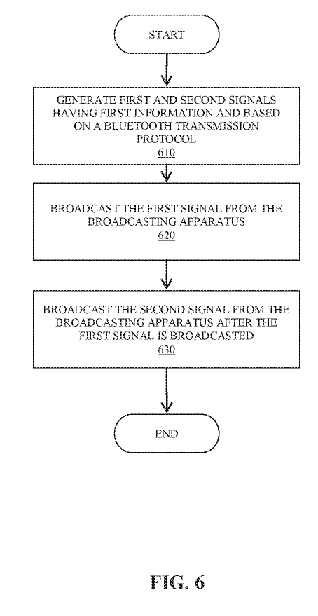

FIG. 6, meant to be illustrative and not limiting, illustrates a flowchart of a method for operating a broadcasting apparatus in accordance with one embodiment of the present invention. The broadcasting apparatus may be similar to broadcasting apparatus (100) of FIG. 1.

At step (610), first and second signals are generated. The first and second signals may have contents that include first information. In addition to that, the first and second signals are in accordance to a Bluetooth transmission protocol. The first and second signals may be generated by a processing circuit (e.g., processing circuit (130) of FIG. 1) together with other circuits (e.g., ROM circuit block (140), RAM circuit block (150) and clock circuitry (160) of FIG. 1). The first information within the first and second signals may be an advertisement content that is provided a user/company.

At step (620), the first signal is broadcasted from the broadcasting apparatus. In one embodiment, the first signal is broadcasted from an antenna (e.g., antenna (111) of FIG. 1). The first signal may be similar to the signal transmitted at T1 of FIG. 2. Prior to broadcasting, the first signal is converted into an RF signal. In one embodiment, the signals may be converted through a transmitter circuit (e.g., transmitters (110) and (120) of FIG. 1).

At step (630), the second signal is broadcasted from broadcasting apparatus. The second signal is broadcasted from a different antenna (e.g., antenna (121) of FIG. 1) than the antenna that broadcasted the first signal. The second signal may be similar to signal transmitted at T2 of FIG. 2. Similar to the first signal, the second signal is also converted into an RF signal prior to broadcasting. The second signal is broadcasted after a predefined period the first signal is broadcasted. In one exemplary embodiment, the second signal is broadcasted 100 milliseconds after the first signal is broadcasted. It should be appreciated that the steps (610-630) may be repeated to transmit second information, third information, and etc. In one embodiment, the steps (610-630) may generate signals similar to signal transmitted at T5 and T6 of FIG. 2

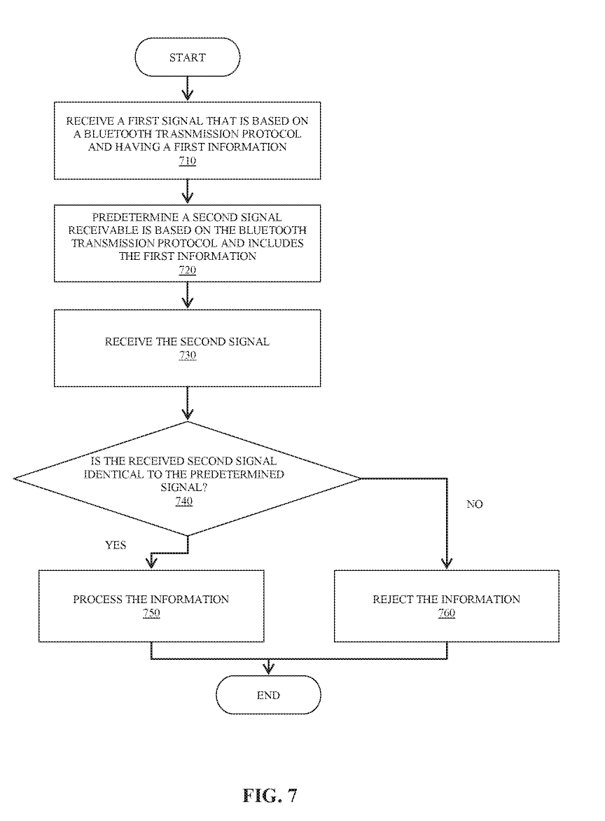

FIG. 7, meant to be illustrative and not limiting, illustrates a flowchart of a method for operating a portable device or a receiver device in accordance with one embodiment of present invention. The portable device may be similar to portable device (350) of FIG. 3 or portable device (450) of FIG. 4.

At step (710), portable device receives a first signal that is in accordance to a Bluetooth transmission protocol and having contents that include first information. The portable device may receive the first signal from a broadcasting apparatus (e.g., broadcasting apparatus (100) of FIG. 1, broadcasting apparatus (300) of FIG. 3 or broadcasting apparatus (400) of FIG. 4). The first information received through first signal may be an advertisement provided a user/company.

At step (720), the portable device predetermines a second signal receivable on a synchronized/pre-known wait time that is in accordance to the Bluetooth transmission protocol and may include the first information. In one embodiment, the predetermination may be performed by a processing circuit within the portable device.

At step (730), the portable device receives a second signal. The portable device may receive the second signal after a predefined period (e.g., 100 milliseconds).

At step (740), the portable device determines whether the second signal is identical to the predetermined signal at step (720). In one embodiment, the portable device may perform such determination by: (a) checking whether the first and second signals include identical information contents, (b) checking whether an averaged RSSI value of the first and second signals is above/at a predefined value, (c) checking whether differences between the RSSI values of the first and second signals is below a predefined value (e.g., 10 decibel-milliwats), (d) checking the predetermined delay time between blocks of (T1+T2+T3+T4)-Delay time-(T5+T6+T7+T8) to check signal flow integrity, and/or (e) checking on whether the second signal received is from identical broadcasting apparatus.

In one embodiment, the method proceeds to step (750) when the first and second signals include identical information contents. In another embodiment, the method also proceeds to step (750) when the averaged RSSI value of the first and second signals is above a predefined value. In a different embodiment, the method also proceeds to step (750) when the differences between the RSSI values of the first and second signals is below a predefined value. In contrast, when the first and second signals include different information contents, the averaged RSSI value between the first and second signals is less than the predefined value, and/or the differences between the RSSI values of the first and second signals is more than the predefined value, the method proceeds to step (760).

At step (750), the information contained in the first and second signals are processed. However, if the method goes to step (760), the information in the first and second signals are rejected. The steps (710-760) performed by the portable device in order to determine a nearest broadcasting apparatus to the portable device and avoid any glitch that may occur when portable device is very near to a broadcasting apparatus or when there are multiple broadcasting apparatus within range of broadcast.

Although the methods of operations were described in a specific order, it should be understood that other operations may be performed in between described operations, described operations may be adjusted so that they occur at slightly different times or described operations may be distributed in a system which allows occurrence of the processing operations at various intervals associated with the processing, as long as the processing of the overlay operations are performed in a desired way.

Although the foregoing invention has been described in some detail for the purposes of clarity, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

1. A broadcasting apparatus (100, 300, 400A, 400B, 500A-500L), comprising:
a module circuit (180) generating first and second signals comprising a particular information, wherein the first and second signals are in accordance to a Bluetooth transmission protocol;
a first antenna circuit (110 and 111) receiving the first signal and broadcasting the first signal; and
a second antenna circuit (120 and 121) receiving the second signal (321A) and broadcasting the second signal (321A) after the first signal is broadcasted.

2. The broadcasting apparatus (100, 300, 400A, 400B, 500A-500L) as defined in claim 1, wherein the module circuit further comprising:
a processing circuit (130) that generates the first and second signals;
a read only memory (ROM) (140) coupled to the processing circuit and stores the particular information, wherein the ROM circuit (140) provides the particular information when requested by the processing circuit (130);
a random access memory (RAM) coupled to the processing circuit and provides a temporary storage for the processing circuit to generate the first and second signals; and
a clock generating circuit (160) that provides a clock signal to the processing circuit (130).

3. The broadcasting apparatus (100, 300, 400A, 400B, 500A-500L) as defined in claim 1, wherein the particular information is an advertisement content provided by a company.

4. The broadcasting apparatus (100, 300, 400A, 400B, 500A-500L) as defined in claim 1, wherein the first antenna circuit (110 and 111) and the second antenna circuit (120 and 121) are located on opposite edges of the broadcasting apparatus (100, 300, 400A, 400B, 500A-500L).

5. The broadcasting apparatus (100, 300, 400A, 400B, 500A-500L) as defined in claim 1, wherein the module circuit (180) further generates third and fourth signals comprising the particular information, and wherein the first antenna circuit (110 and 111) broadcast the third signal after the first and second signals are broadcasted, and wherein the second antenna circuit (120 and 121) broadcast the fourth signal after the first, second and third signals are broadcasted.

6. The broadcasting apparatus (100, 300, 400A, 400B, 500A-500L) as defined in claim 1, wherein module circuit (180) further generates third and fourth signals comprising a different information than the first and second signals, and wherein the first antenna circuit (110 and 111) broadcast out the third signal after the first and second signals are broadcasted, and wherein the second antenna circuit (120 and 121) broadcast out the fourth signal after the first, second and third signals are broadcasted.

7. The broadcasting apparatus (100, 300, 400A, 400B, 500A-500L) as defined in claim 1, wherein the Bluetooth transmission protocol is Bluetooth version 4.x.

8. A method of operating a broadcasting apparatus (100, 300, 400A, 400B, 500A-500L), the method comprising:
generating first and second signals that are in accordance to a Bluetooth transmission protocol, wherein the first and second signals contents include a first information;
broadcasting the first signal out from the broadcasting apparatus (100, 300, 400A, 400B, 500A-500L); and
broadcasting the second signal out from the broadcasting apparatus (100, 300, 400A, 400B, 500A-500L) after the first signal is broadcasted.

9. The method as defined in claim 8, wherein the first information includes an advertisement content provided by a user.

10. The method as defined in claim 8, further comprising:
generating third and fourth signals that are in accordance to the Bluetooth transmission protocol, wherein the third and fourth signals contents include a second information and are generated after the first and second signals are generated;
broadcasting the third signal out from the broadcasting apparatus (100, 300, 400A, 400B, 500A-500L) after the first and second signals are broadcasted; and
broadcasting the fourth signal out from the broadcasting apparatus (100, 300, 400A, 400B, 500A-500L) after the third signal is broadcasted.

11. The method as defined in claim 8, further comprising:
generating third and fourth signals that are in accordance to the Bluetooth transmission protocol, wherein the third and fourth signals contents include the first information and are generated after the first and second signals are generated;
broadcasting the third signal out from the broadcasting apparatus (100, 300, 400A, 400B, 500A-500L) after the first and second signals are broadcasted; and
broadcasting the fourth signal out from the broadcasting apparatus (100, 300, 400A, 400B, 500A-500L) after the third signal is broadcasted.

12. The method as defined in claim 8, wherein the Bluetooth transmission protocol is a Bluetooth protocol version 4.x.

13. A method of predetermined receiving broadcasted information using a portable device (450, 550A-550C), the method comprising:
receiving a first signal that is in accordance to a Bluetooth transmission protocol and is having contents that include a first information;
after receiving the first signal, predetermining that a second signal is in accordance to a Bluetooth transmission protocol receivable and is having contents that also include the first information; and
receiving the second signal.

14. The method as defined in claim 13, further comprising:
determining whether the second signal contents include the first information;
when the second signal is having contents that include the first information, processing the first information; and
when the second signal is having contents that do not include the first information, rejecting the first information.

15. The method as defined in claim 13, further comprising:
determining an averaged received signal strength indicator (RSSI) value of the first and second signals;
when the RSSI value is greater than a predefined value, accepting the first and second signals; and
when the RSSI value is less than a predefined value, rejecting the first and second signals.

16. The method as defined in claim 13, further comprising:
determining differences between received signal strength indicator (RSSI) values of the first and second signals;
when the RSSI value is less than a predefined value, accepting the first and second signals; and
when the RSSI value is greater than a predefined value, rejecting the first and second signals.

17. The method as defined in claim 16, wherein the predefined value is 10 decibel-milliwatts (dBm).

18. The method as defined in claim 13, further comprising:
receiving a third signal in accordance to the Bluetooth transmission protocol and is having contents that include the first information;
after receiving the third signal, predetermining that a fourth signal receivable is in accordance to the Bluetooth transmission protocol and is having contents that includes the first information; and
receiving the fourth signal.

19. The method as defined in claim 13, further comprising:
receiving a third signal in accordance to the Bluetooth transmission protocol and is having contents that include a second information;
after receiving the third signal, predetermining that a fourth signal receivable is in accordance to the Bluetooth transmission protocol and is having contents that includes the second information; and
receiving the fourth signal based.

20. The method as defined in claim 18, further comprising:
determining whether the fourth signal is having contents that include the second information, an averaged received signal strength indicator (RSSI) value of the third and fourth signals, and a difference in the RSSI values of the third and fourth signals;
only when the fourth signal is having the contents that include the second information, the averaged RSSI value between the third and fourth signals is greater than a predefined value and the difference in the RSSI values of the third and fourth signals less than another predefined value, processing the second information.
